(19) United States
(12) Patent Application Publication
(10) Pub. No.: US 2026/0331748 A1
(43) Pub. Date: Oct. 22, 2026

(54) MOUNTING STRUCTURE, ANTENNA MODULE, AND COMMUNICATION DEVICE

(71) Applicant: Murata Manufacturing Co., Ltd., Nagaokakyo-shi (JP)

(72) Inventor: Yosuke SATO, Nagaokakyo-shi (JP)

(73) Assignee: Murata Manufacturing Co., Ltd., Nagaokakyo-shi (JP)

(21) Appl. No.: 19/691,618

(22) Filed: May 29, 2026

Related U.S. Application Data
(63) Continuation-in-part of application No. PCT/JP2024/036977, filed on Oct. 17, 2024.

(30) Foreign Application Priority Data
Dec. 20, 2023 (JP) 2023-214640

(51) Int. Cl. H01Q 1/12; H01Q 1/38

(52) U.S. Cl. CPC H01Q 1/12; H01Q 1/38

(57) ABSTRACT

A mounting structure includes a dielectric; a ground electrode disposed at the dielectric, a first line disposed at the dielectric so as to oppose the ground electrode in a normal direction to the dielectric, a second line disposed at the dielectric so as to oppose the ground electrode at a position between the first line and the ground electrode in the normal direction; a connecting conductor connecting the first and second lines, and a stub extending from a connection portion of the first line. The stub opposes the ground electrode and the second line. In the normal direction, a thickness of the first line is greater than a thickness of the second line. The first line, the second line, and the stub each extend in the longitudinal direction. When viewed from the normal direction, at least a portion of the stub overlaps the second line in the longitudinal direction.

### CROSS-REFERENCE TO RELATED APPLICATIONS

This application is a continuation-in-part of International Application No. PCT/JP2024/036977, filed Oct. 17, 2024, which claims priority to Japanese Patent Application No. 2023-214640, filed Dec. 20, 2023, the entire contents of each of which are incorporated herein by reference.

### TECHNICAL FIELD

The present disclosure relates to a mounting structure of a transmission line that transmits a signal, an antenna module equipped with the mounting structure, and a communication device equipped with the antenna module.

### BACKGROUND ART

A mounting structure of transmission lines that transmit a signal between multiple lines having different thicknesses is known. In such a mounting structure, the impedance may differ between a thicker transmission line and a thinner transmission line due to, for example, a difference in capacitive component caused by the difference between the distance from the thicker transmission line to the ground electrode and the distance from the thinner transmission line to the ground electrode, which may increase the transmission loss between the transmission lines.

Regarding this, Japanese Unexamined Patent Application Publication No. 2006-128868 (Patent Document 1) discloses a connection circuit in which a thicker transmission line and a thinner transmission line formed on a conductor chassis are connected by a connecting conductor and in which a high-impedance line is connected in parallel to the thinner transmission line.

### CITATION LIST

### Patent Document

Patent Document 1: Japanese Unexamined Patent Application Publication No. 2006-128868

### SUMMARY

According to the present disclosure, a mounting structure of a transmission line that transmits a signal includes: a dielectric; a ground electrode disposed at the dielectric; a first line disposed at the dielectric so as to oppose the ground electrode in a normal direction being normal to the dielectric; a second line disposed at the dielectric so as to oppose the ground electrode at a position between the first line and the ground electrode in the normal direction; a connecting conductor connecting the first line and the second line; and a stub extending from a connection portion of the first line. The connection portion is connected to the connecting conductor and the stub is disposed at the dielectric so as to oppose the ground electrode and the second line. In the normal direction, a thickness of the first line is greater than a thickness of the second line. The first line extends in a longitudinal direction. The second line extends along the longitudinal direction. The stub extends in the longitudinal direction. When the dielectric is viewed from the normal direction, at least a portion of the stub overlaps the second line in the longitudinal direction.

In the mounting structure according to the present disclosure, a strip line is formed by interposing the second line between the stub and the ground electrode, and the strip line is provided between a microstrip line formed of the first line and the ground electrode and a microstrip line formed of the second line and the ground electrode. Adjusting the impedance using the above strip line enables the favorable impedance matching even in a structure in which a thicker first line and a thinner second line are connected in a dielectric layer interposed between the first line and the second line.

### BRIEF DESCRIPTION OF DRAWINGS

FIG. 1 is a perspective view illustrating a mounting structure of a transmission line according to Embodiment 1.

FIG. 2 is a section view illustrating the mounting structure of Embodiment 1.

FIG. 3 is a view illustrating a configuration of an antenna device equipped with the mounting structure of Embodiment 1.

FIG. 4 is a view illustrating a configuration of a communication device and an antenna module equipped with the antenna device of Embodiment 1.

FIG. 5 is a view illustrating a configuration of an antenna device according to Embodiment 2.

FIG. 6 is a view illustrating a configuration of an antenna device according to Embodiment 3.

FIG. 7 is a view illustrating a configuration of an antenna device according to Embodiment 4.

FIG. 8 is a view illustrating a configuration of an antenna device according to Embodiment 5.

FIG. 9 is a perspective view illustrating a mounting structure of a transmission line according to a modification example.

FIG. 10 is a cross-sectional view illustrating the mounting structure of the transmission line of the modification example.

FIG. 11 is a cross-sectional view illustrating the mounting structure of the transmission line of Embodiment 6.

FIG. 12 is a cross-sectional view illustrating the mounting structure of the transmission line of Embodiment 7.

### DESCRIPTION OF EMBODIMENTS

According to the connection circuit disclosed in Japanese Unexamined Patent Application Publication No. 2006-128868, the high-impedance line can adjust the difference in the capacitive component caused by the difference between the distance from the thicker transmission line to the conductor chassis and the distance from the thinner transmission line to the conductor chassis, thereby enabling impedance matching between the thicker transmission line and the thinner transmission line.

However, the inventor has recognized that the impedance matching technique disclosed in Japanese Unexamined Patent Application Publication No. 2006-128868 is applicable only to a structure in which two transmission lines of different thicknesses are disposed on the principal surface of the conductor chassis. It is difficult to carry out favorable impedance matching, using this technique, for a structure in which the thinner transmission line is disposed inside the dielectric and connected to the thicker transmission line with a layer of the dielectric interposed therebetween.

Embodiments of the present disclosure will be described in detail with reference to the drawings. The same or corresponding parts are designated by the same reference signs in the drawings, and their descriptions will not be repeated.

### Embodiment 1

### [Mounting Structure]

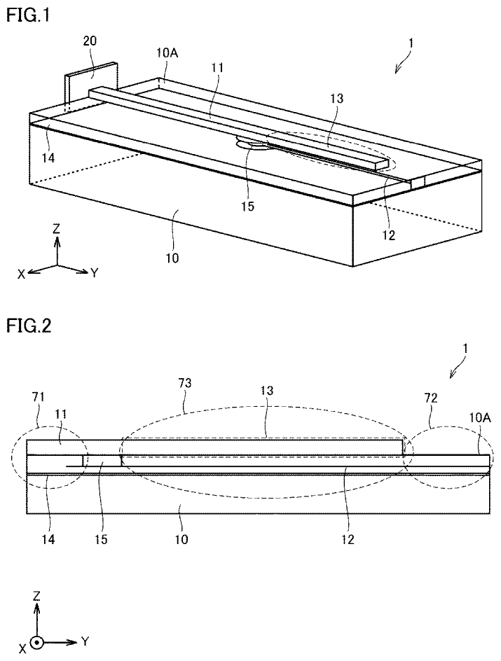

A mounting structure 1 of a transmission line according to Embodiment 1 will be described with reference to FIGS. 1 and 2. FIG. 1 is a perspective view illustrating the mounting structure 1 of the transmission line according to Embodiment 1. FIG. 2 is a section view illustrating the mounting structure 1 of Embodiment 1. For example, the mounting structure 1 is a mounting substrate that constitutes a transmission line that transmits radio frequency signals.

As illustrated in FIGS. 1 and 2, the mounting structure 1 includes a dielectric 10, a ground electrode 14, a first line 11, a second line 12, and a connecting conductor 15. In the following, an axis along the width of the dielectric 10 is defined as the X-axis, an axis along the length of the dielectric 10 is defined as the Y-axis, and an axis along the height of the dielectric 10 (i.e., in the direction normal to the dielectric 10) is defined as the Z-axis. As used herein, “extending direction” or “longitudinal direction” refers to the direction along which the first and second lines extend, which in the illustrated embodiment is the Y-axis direction. As used herein, “normal direction” refers to the direction normal to a principal surface of the dielectric, which in the illustrated embodiment is the Z-axis direction. Configurations of the mounting structure 1 are described on the basis of the above definitions.

The dielectric 10 is a multilayer resin substrate formed by laminating multiple resin layers. The dielectric 10 is made of a resin, such as a low temperature co-fired ceramic (LTCC), epoxy, or polyimide. The dielectric 10 may be made of other resins, such as liquid crystal polymer (LCP) having a lower dielectric constant, fluorine-based resins, or ceramics other than LTCC.

The ground electrode 14 is formed on an inner layer of the dielectric 10. The ground electrode 14 has a tabular shape stretching along the X-Y plane.

The first line 11 is provided at the dielectric 10 so as to oppose the ground electrode 14. In the example illustrated in FIG. 1 and FIG. 2, the first line 11 is disposed on a principal surface 10A of the dielectric 10. The first line 11 is shaped like a cuboid elongated in the Y-axis direction on the principal surface 10A of the dielectric 10. As illustrated in FIG. 2, the first line 11 and the ground electrode 14 form a microstrip line 71 in the mounting structure 1.

The second line 12 is formed on an inner layer of the dielectric 10 between the first line 11 and the ground electrode 14 in the Z-axis direction of the dielectric 10 so as to oppose the first line 11 and the ground electrode 14. More specifically, the second line 12 is formed on an inner layer of the dielectric 10, the inner layer being positioned between the principal surface 10A of the dielectric 10 on which the first line 11 is formed and the inner layer of the dielectric 10 on which the ground electrode 14 is formed. The second line 12 extends in the positive Y-axis direction, which is the same as the direction in which the first line 11 extends. As illustrated in FIG. 2, the second line 12 and the ground electrode 14 form a microstrip line 72 in the mounting structure 1.

As illustrated in FIG. 1, an end of the first line 11 is connected to an electrode plate 20. The electrode plate 20 receives a radio frequency signal from a feed wire formed on another substrate and transmits the signal to the mounting structure 1. The connecting conductor 15 is connected to the side of the first line 11 that is not connected to the electrode plate 20. The first line 11 is connected to the second line 12 via the connecting conductor 15. More specifically, the connecting conductor 15 is formed inside the dielectric 10 so as to extend in the Z-axis direction between the principal surface 10A of the dielectric 10 on which the first line 11 is formed and the inner layer of the dielectric 10 on which the second line 12 is formed. The end of the second line 12 on the side not connected to the connecting conductor 15 is connected to a radiation electrode that radiates a radio frequency signal.

In other words, a radio frequency signal transmitted via the electrode plate 20 is further transmitted through the first line 11, the connecting conductor 15, and the second line 12 and is radiated by the radiation electrode.

In the Z-axis direction, the thickness of the first line 11 (i.e., the dimension in the Z-axis direction) is greater than the thickness of the second line 12 (i.e., the dimension in the Z-axis direction). Moreover, when the principal surface 10A of the dielectric 10 is viewed from the Z-axis direction, the width of the first line 11 (i.e., the dimension in the X-axis direction) is greater than the width of the second line 12 (i.e., the dimension thereof in the X-axis direction).

Accordingly, since the first line 11 is a line having a section (X-Z section) large enough, the first line 11 provides stable electrical conduction with the electrode plate 20 and can receive a radio frequency signal with reduced transmission loss and transmit the received radio frequency signal to the second line 12 with reduced transmission loss.

On the other hand, the second line 12 is a line having a smaller cross section (X-Z section) than that of the first line 11, and accordingly it is not necessary to increase the size of the dielectric 10 for the second line 12 even if the second line 12 is formed inside the dielectric 10. This can reduce the size of the dielectric 10.

When the principal surface 10A of the dielectric 10 is viewed from the Z-axis direction, the size of the cross section (X-Y section) of the connecting conductor 15 is greater than the width of the second line 12 (i.e., the dimension in the X-axis direction) and smaller than the width of the first line 11 (i.e., the dimension in the X-axis direction). In the example illustrated in FIG. 1, the connecting conductor 15 has a cylindrical shape, and the diameter of the cross section (i.e., X-Y section) of the connecting conductor 15 is greater than the width of the second line 12 (i.e., the dimension in the X-axis direction) and smaller than the width of the first line 11 (i.e., the dimension in the X-axis direction).

When a manufacturer connects the first line 11 and the second line 12 using the connecting conductor 15, this allows the manufacturer to connect the connecting conductor 15 easily to the first line 11 within the range of the width of the first line 11 (i.e., the dimension in the X-axis direction) and also allows the manufacturer to connect the second line 12 easily to the connecting conductor 15 within the range of the cross section (i.e., X-Y section) of the connecting conductor 15.

In the mounting structure 1 structured as above, the distance between the first line 11 and the ground electrode 14 in the microstrip line 71 is different from the distance between the second line 12 and the ground electrode 14 in the microstrip line 72. In the example illustrated in FIGS. 1 and 2, the distance between the second line 12 and the ground electrode 14 in the microstrip line 72 is smaller than the distance between the first line 11 and the ground electrode 14 in the microstrip line 71. This causes the capacitive component of the microstrip line 72 to increase compared with the microstrip line 71, which may cause an impedance mismatch between the transmission line constituting the microstrip line 71 and the transmission line constituting the microstrip line 72.

Furthermore, the difference in thickness between the first line 11 and the second line 12 may also cause an impedance mismatch between the transmission line constituting the microstrip line 71 and the transmission line constituting the microstrip line 72.

In this regard, the mounting structure 1 of Embodiment 1 is configured to include a stub 13 that extends from the connection portion of the first line 11 that is connected to the connecting conductor 15, thereby achieving favorable impedance matching between the transmission line constituting the microstrip line 71 and the transmission line constituting the microstrip line 72.

More specifically, in the mounting structure 1, the connecting conductor 15 is connected to the middle of the first line 11, and a portion of the first line 11 extending from the connection portion connected to the connecting conductor 15 functions as the stub 13. In other words, the conductor functioning as the stub 13 is the same as the conductor constituting the first line 11. The stub 13, which is a portion of the first line 11, is formed on the principal surface 10A of the dielectric 10 so as to oppose the second line 12 and the ground electrode 14 and so as to extend in the extending direction in which the second line 12 extends (i.e., in the positive Y-axis direction). The end of the stub 13 positioned opposite to the connection portion connected to the connecting conductor 15 (i.e., the end positioned in the positive Y-axis direction) is an open end. In other words, the stub 13 is configured as an open stub.

In the Y-axis direction, the length of the portion of the first line 11 that does not function as the stub 13 is smaller than the length of the portion that functions as the stub 13 and also smaller than the length of the second line 12. In the Z-axis direction, the distance between the stub 13 and the second line 12 is the same as the distance between the second line 12 and the ground electrode 14.

The stub 13 is part of the first line 11. Accordingly, in the Z-axis direction, the thickness of the stub 13 (i.e., the dimension in the Z-axis direction) is the same as the thickness of the first line 11 (i.e., the dimension in the Z-axis direction) and is greater than the thickness of the second line 12 (i.e., the dimension in the Z-axis direction). In addition, when the principal surface 10A of the dielectric 10 is viewed from the Z-axis direction, the width of the stub 13 (i.e., the dimension in the X-axis direction) is greater than the width of the second line 12 (i.e., the dimension in the X-axis direction).

When the principal surface 10A of the dielectric 10 is viewed from the Z-axis direction, at least a portion of the stub 13 overlaps the second line 12 in the extending direction of the second line (i.e., in the Y-axis direction). For example, as illustrated in FIG. 1, when the principal surface 10A of the dielectric 10 is viewed from the Z-axis direction, the stub 13 completely overlaps the second line 12 in the width direction thereof (i.e., in the X-axis direction).

The mounting structure 1 structured as above has a strip line 73 formed between the microstrip line 71 and the microstrip line 72 in the Y-axis direction. In the strip line 73, the second line 12 is interposed between the stub 13 and the ground electrode 14.

By providing the strip line 73 using the stub 13 in the transmission path from the microstrip line 71 to the microstrip line 72, the mounting structure 1 can adjust the impedance so as to avoid the mismatch between the transmission line of the microstrip line 71 and the transmission line of the microstrip line 72.

More specifically, a portion of the second line 12 that overlaps the stub 13 in the Y-axis direction constitutes the strip line 73, and the impedance of the transmission line of the strip line 73 is smaller than the impedance of the transmission line of the microstrip line 71 of the first line 11. On the other hand, a portion of the second line 12 that does not overlap with the stub 13 in the Y-axis direction constitutes the microstrip line 72, and the impedance of the transmission line of the microstrip line 72 is the same as the impedance of the transmission line of the microstrip line 71 of the first line 11.

For example, in the case in which the impedance of the transmission line of the microstrip line 71 is designed to be 50 Ω, the impedance of the transmission line of the microstrip line 72 would be smaller than 50 Ω if the strip line 73 was not provided. In the mounting structure 1, however, the strip line 73 adjusts the impedance to achieve the impedance of the transmission line of the microstrip line 72 to 50 Ω, which is the same as the impedance of the transmission line of the microstrip line 71.

The mounting structure 1 of Embodiment 1 is structured such that the connecting conductor 15 connects the first line 11 and the second line 12 that have different thicknesses and that are positioned with a layer of the dielectric 10 being interposed therebetween. Even with this configuration, the mounting structure 1 can achieve favorable impedance matching and suppress an increase in transmission loss.

In the Z-axis direction, the thickness of the stub 13 (i.e., the dimension in the Z-axis direction) is the same as the thickness of the first line 11 (i.e., the dimension in the Z-axis direction). Accordingly, when the stub 13 is considered as a transmission line, the impedance of the stub 13 is equal to the impedance of the first line 11. As a result, the mounting structure 1 can suppress unwanted radiation from the stub 13 between the first line 11 and the stub 13.

When the principal surface 10A of the dielectric 10 is viewed from the Z-axis direction, the width of the stub 13 (i.e., the dimension in the X-axis direction) is greater than the width of the second line 12 (i.e., the dimension in the X-axis direction) so that the mounting structure 1 can effectively allow the stub 13 to function as a ground electrode for the second line 12 in the strip line 73.

In the Z-axis direction, the distance between the stub 13 and the second line 12 is the same as the distance between the second line 12 and the ground electrode 14, which enables the mounting structure 1 to effectively adjust the impedance using the strip line 73.

### [Antenna Device]

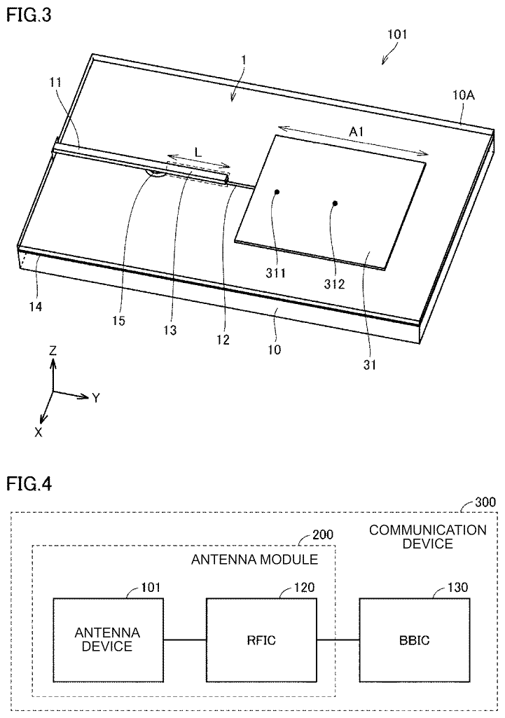

An antenna device 101 according to Embodiment 1 will be described with reference to FIG. 3. FIG. 3 is a view illustrating a structure of the antenna device 101 equipped with the mounting structure 1 of Embodiment 1.

As illustrated in FIG. 3, the antenna device 101 is a microstrip antenna (a patch antenna) equipped with the mounting structure 1 and a radiation electrode 31. The radiation electrode 31 is a tabular electrode that radiates, as a radio wave, a radio frequency signal transmitted from the mounting structure 1.

The radiation electrode 31 is formed on the dielectric 10 of the mounting structure 1 and is connected to the second line 12 via a connecting conductor. The point of the radiation electrode 31 to which the second line 12 is connected is a feed point 311. More specifically, an end portion of the second line 12 in the Y-axis direction is connected to the first line 11 via the connecting conductor 15, and the other end portion of the second line 12 in the Y-axis direction is connected to the radiation electrode 31 via a connecting conductor. The other end portion of the second line 12, which is connected to the radiation electrode 31, is a portion constituting the microstrip line 72 in which the stub 13 is not included. Accordingly, the stub 13 is separated from the radiation electrode 31 by a predetermined distance and does not affect the radiation electrode 31 radiating the radio frequency signal.

When the radiation electrode 31 is viewed from the Z-axis direction, the length A1 of the radiation electrode 31 in a direction connecting the feed point 311 and a center point 312 (for example, in the Y-axis direction) is one half of the wavelength of a radio frequency signal transmitted through the substrate in the frequency band supported by the antenna device 101. In other words, the length A1 of the radiation electrode 31 in the Y-axis direction is one half of the wavelength of the radio frequency signal transmitted by the first line 11 and the second line 12 in the frequency band supported by the antenna device 101.

The length L of the stub 13 is one-fourth of the wavelength of a radio frequency signal transmitted through the substrate in the frequency band supported by the antenna device 101. In other words, the length L of the stub 13 is one-fourth of the wavelength of the radio frequency signal transmitted by the first line 11 and the second line 12 in the frequency band supported by the antenna device 101. From another perspective, the length L of the stub 13 is within ±30% of one half of the length A1 of the radiation electrode 31 in the Y-axis direction. Note that the frequency band that is supported by the antenna device 101 may be, for example, millimeter radio waves with a center frequency of 28 GHz, 39 GHz, or 60 GHz or may be radio waves in other frequency bands.

In the antenna device 101 structured as above, the first line 11 and the second line 12 of the mounting structure 1 are impedance-matched, and a radio frequency signal is transmitted from the electrode plate 20 to the first line 11 and further to the second line 12 while reducing transmission loss. The radio frequency signal transmitted to the second line 12 is further transmitted to the radiation electrode 31 and is radiated to the outside by the radiation electrode 31.

Accordingly, the antenna device 101 can receive the radio frequency signal transmitted from the electrode plate 20 via the first line 11 and the second line 12 of the mounting structure 1 while reducing transmission loss, and then the antenna device 101 can radiate the radio frequency signal efficiently.

### [Antenna Module, Communication Device]

An antenna module 200 and a communication device 300 according to Embodiment 1 will be described with reference to FIG. 4. FIG. 4 is a view illustrating a configuration of the communication device 300 and the antenna module 200 equipped with the antenna device 101 of Embodiment 1. The communication device 300 is, for example, a mobile terminal, such as a mobile phone, a smartphone, or a tablet, or another personal computer (PC) having a communication function.

As illustrated in FIG. 4, the antenna module 200 includes the antenna device 101 and an radio frequency integrated circuit (RFIC) 120. The antenna device 101 includes the mounting structure 1 and the radiation electrode 31. The RFIC 120 supplies a radio frequency signal to the antenna device 101, and the radiation electrode 31 radiates the radio frequency signal transmitted from the mounting structure 1 of the antenna device 101. The communication device 300 is equipped with the antenna module 200. More specifically, the communication device 300 includes the antenna module 200 and a baseband integrated circuit 130 (hereinafter referred to as “BBIC 130”) that constitutes a baseband signal processing circuit.

The communication device 300 up-converts a signal transmitted from the BBIC 130 to the antenna module 200 into a radio frequency signal and radiates the radio frequency signal from the antenna device 101. Moreover, the communication device 300 down-converts a radio frequency signal received by the antenna device 101 and processes the down-converted signal using the BBIC 130.

As described above, the antenna device 101 that includes the mounting structure 1 of the transmission line according to Embodiment 1 can be used in the antenna module 200 mounted on the communication device 300 such as a mobile terminal.

### Embodiment 2

An antenna device 102 according to Embodiment 2 will be described with reference to FIG. 5. The description of the antenna device 102 of Embodiment 2 focuses only on portions that differ from those of the antenna device 101 of Embodiment 1 and omits the other portions. As is the case for the antenna device 101 of Embodiment 1, the antenna device 102 of Embodiment 2 includes the mounting structure 1 described using FIGS. 1 and 2. FIG. 5 is a view illustrating a structure of the antenna device 102 of Embodiment 2.

As illustrated in FIG. 5, the antenna device 102 is a planar inverted F antenna (PIFA) equipped with the mounting structure 1 and a radiation electrode 32. The radiation electrode 32 is a tabular electrode that radiates, as a radio wave, a radio frequency signal transmitted from the mounting structure 1.

The radiation electrode 32 has a feed point 321 and a grounding point 322. The second line 12 is connected to the radiation electrode 32 at the feed point 321 via another connecting conductor formed in the dielectric 10 of the mounting structure 1, and the grounding point 322 is connected to the ground electrode 14 via a connecting conductor. The stub 13 is separated from the radiation electrode 32 by a predetermined distance and does not affect the radiation electrode 32 radiating the radio frequency signal.

When the radiation electrode 32 is viewed from the Z-axis direction, the sum of the length A2 of the radiation electrode 32 in the Y-axis direction and the length B2 of the radiation electrode 32 in the X-axis direction (i.e., A2+B2) is one-fourth of the wavelength of a radio frequency signal transmitted through the substrate in the frequency band supported by the antenna device 102. In other words, the sum of the length A2 of the radiation electrode 32 in the Y-axis direction and the length B2 of the radiation electrode 32 in the X-axis direction (i.e., A2+B2) is one-fourth of the wavelength of the radio frequency signal transmitted by the first line 11 and the second line 12 in the frequency band supported by the antenna device 102.

The length L of the stub 13 is one-fourth of the wavelength of a radio frequency signal transmitted through the substrate in the frequency band supported by the antenna device 102. In other words, the length L of the stub 13 is one-fourth of the wavelength of the radio frequency signal transmitted by the first line 11 and the second line 12 in the frequency band supported by the antenna device 102. From another perspective, the length L of the stub 13 is within ±30% of the sum (i.e., A2+B2) of the length A2 of the radiation electrode 32 in the Y-axis direction and the length B2 of the radiation electrode 32 in the X-axis direction.

In the antenna device 102 structured as above, the first line 11 and the second line 12 of the mounting structure 1 are impedance-matched, and a radio frequency signal is transmitted from the electrode plate 20 to the first line 11 and further to the second line 12 while reducing transmission loss. The radio frequency signal transmitted to the second line 12 is further transmitted to the radiation electrode 32 and is radiated to the outside by the radiation electrode 32.

Accordingly, the antenna device 102 can receive the radio frequency signal transmitted from the electrode plate 20 via the first line 11 and the second line 12 of the mounting structure 1 while reducing transmission loss, and then the antenna device 102 can radiate the radio frequency signal efficiently.

Note that the antenna device 102 of Embodiment 2 can be used in the antenna module 200 mounted on the communication device 300, as is the case for the antenna device 101 of Embodiment 1.

### Embodiment 3

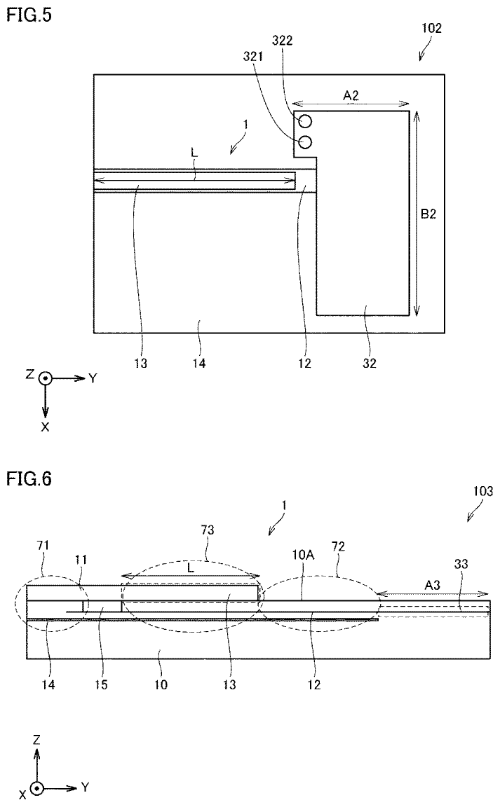

An antenna device 103 according to Embodiment 3 will be described with reference to FIG. 6. The description of the antenna device 103 of Embodiment 3 focuses only on portions that differ from those of the antenna device 101 of Embodiment 1 and omits the other portions. As is the case for the antenna device 101 of Embodiment 1, the antenna device 103 of Embodiment 3 includes the mounting structure 1 described using FIGS. 1 and 2. FIG. 6 is a view illustrating a structure of the antenna device 103 of Embodiment 3.

As illustrated in FIG. 6, the antenna device 103 is a monopole antenna equipped with the mounting structure 1 and a radiation electrode 33. The radiation electrode 33 is a linear electrode that radiates, as a radio wave, a radio frequency signal transmitted from the mounting structure 1.

The radiation electrode 33 is a portion of the second line 12 and is disposed on the dielectric 10 of the mounting structure 1. More specifically, the second line 12 constitutes a microstrip line 72 together with the ground electrode 14 but extends longer in the positive Y-axis direction than the ground electrode 14. In other words, when the principal surface 10A of the dielectric 10 is viewed from the Z-axis direction, the portion of the second line 12 that does not overlap the ground electrode 14 functions as the radiation electrode 33 (monopole antenna). Note that the radiation electrode 33 is not limited to being a portion of the second line 12 but may be formed of a conductor separated from the second line 12.

The length A3 of the radiation electrode 33 in the Y-axis direction is one-fourth of the wavelength of a radio frequency signal transmitted through the substrate in the frequency band supported by the antenna device 103. In other words, the length A3 of the radiation electrode 33 in the Y-axis direction is one-fourth of the wavelength of the radio frequency signal transmitted by the first line 11 and the second line 12 in the frequency band supported by the antenna device 103.

The length L of the stub 13 is one-fourth of the wavelength of a radio frequency signal transmitted through the substrate in the frequency band supported by the antenna device 103. In other words, the length L of the stub 13 is one-fourth of the wavelength of the radio frequency signal transmitted by the first line 11 and the second line 12 in the frequency band supported by the antenna device 103. From another perspective, the length L of the stub 13 is within ±30% of the length A3 of the radiation electrode 33 in the Y-axis direction.

In the antenna device 103 structured as above, the first line 11 and the second line 12 of the mounting structure 1 are impedance-matched, and a radio frequency signal is transmitted from the electrode plate 20 to the first line 11 and further to the second line 12 while reducing transmission loss. The radio frequency signal transmitted to the second line 12 is radiated to the outside by the radiation electrode 33 that is part of the second line 12.

Accordingly, the antenna device 103 can receive the radio frequency signal transmitted from the electrode plate 20 via the first line 11 and the second line 12 of the mounting structure 1 while reducing transmission loss and then radiate the radio frequency signal efficiently.

Note that the antenna device 103 of Embodiment 3 can be used in the antenna module 200 mounted on the communication device 300, as is the case for the antenna device 101 of Embodiment 1.

### Embodiment 4

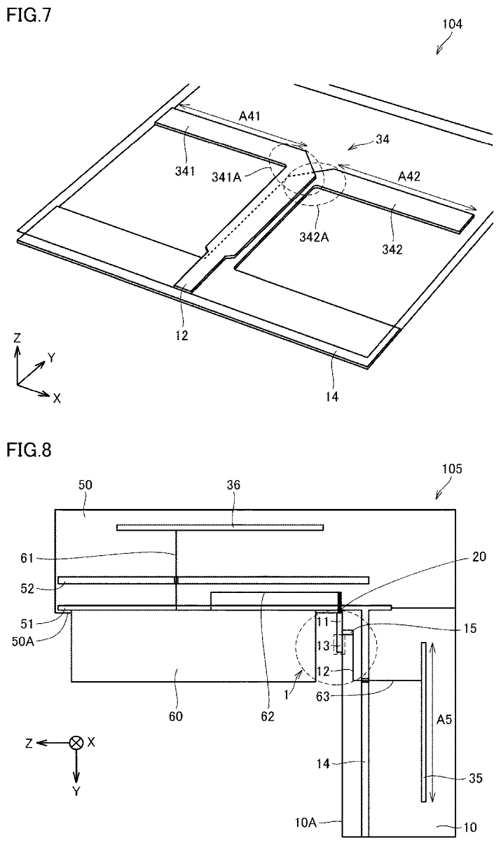

An antenna device 104 according to Embodiment 4 will be described with reference to FIG. 7. The description of the antenna device 104 of Embodiment 4 focuses only on portions that differ from those of the antenna device 101 of Embodiment 1 and omits the other portions. As is the case for the antenna device 101 of Embodiment 1, the antenna device 104 of Embodiment 4 includes the mounting structure 1 described using FIGS. 1 and 2. FIG. 7 is a view illustrating a structure of the antenna device 104 of Embodiment 4.

As illustrated in FIG. 7, the antenna device 104 is a dipole antenna equipped with the mounting structure 1 and a radiation electrode 34. The radiation electrode 34 is a tabular electrode that radiates, as a radio wave, a radio frequency signal transmitted from the mounting structure 1.

The radiation electrode 34 is disposed on the dielectric 10 of the mounting structure 1 and includes a first radiation electrode 341 connected to the second line 12 and a second radiation electrode 342 connected to the ground electrode 14.

The first radiation electrode 341 extends from the second line 12 in the positive Y-axis direction and bends at a first bend 341A toward the negative X-axis direction and further extends in the negative X-axis direction. The second radiation electrode 342 extends from the ground electrode 14 in the positive Y-axis direction and bends at a second bend 342A toward the positive X-axis direction, in other words, toward the side opposite to the side on which the first radiation electrode 341 extends, and the second radiation electrode 342 further extends in the positive X-axis direction. When the principal surface 10A of the dielectric 10 is viewed from the Z-axis direction, the first bend 341A overlaps at least part of the second bend 342A.

When the principal surface 10A of the dielectric 10 is viewed from the Z-axis direction, the portion of the first radiation electrode 341 that extends in the negative X-axis direction does not overlap the ground electrode. The stub 13 is separated from the radiation electrode 34 by a predetermined distance and does not affect the radiation electrode 34 radiating the radio frequency signal.

The length A41 of the portion of the first radiation electrode 341 that extends in the negative X-axis direction from the first bend 341A is one-fourth of the wavelength of a radio frequency signal transmitted through the substrate in the frequency band supported by the antenna device 104. In other words, the length A41 of the first radiation electrode 341 in the X-axis direction is one-fourth of the wavelength of the radio frequency signal transmitted by the first line 11 and the second line 12 in the frequency band supported by the antenna device 104.

The length A42 of the portion of the second radiation electrode 342 that extends in the positive X-axis direction from the second bend 342A is one-fourth of the wavelength of a radio frequency signal transmitted through the substrate in the frequency band supported by the antenna device 104. In other words, the length A42 of the second radiation electrode 342 in the X-axis direction is one-fourth of the wavelength of the radio frequency signal transmitted by the first line 11 and the second line 12 in the frequency band supported by the antenna device 104.

In other words, the sum of the length A41 of the first radiation electrode 341 in the X-axis direction and the length A42 of the second radiation electrode 342 in the X-axis direction (i.e., A41+A42) is one half of the wavelength of a radio frequency signal transmitted by the first line 11 and the second line 12 in the frequency band supported by the antenna device 104.

The length L of the stub 13 is one-fourth of the wavelength of a radio frequency signal transmitted through the substrate in the frequency band supported by the antenna device 104. In other words, the length L of the stub 13 is one-fourth of the wavelength of the radio frequency signal transmitted by the first line 11 and the second line 12 in the frequency band supported by the antenna device 104. From another perspective, the length L of the stub 13 is within ±30% of one half of the sum (i.e., A41+A42) of the length A41 of the first radiation electrode 341 in the X-axis direction and the length A42 of the second radiation electrode 342 in the X-axis direction.

In the antenna device 104 structured as above, the first line 11 and the second line 12 of the mounting structure 1 are impedance-matched, and a radio frequency signal is transmitted from the electrode plate 20 to the first line 11 and further to the second line 12 while reducing transmission loss. The radio frequency signal transmitted to the second line 12 is further transmitted to the radiation electrode 34 and is radiated to the outside by the radiation electrode 34.

Accordingly, the antenna device 104 can receive the radio frequency signal transmitted from the electrode plate 20 via the first line 11 and the second line 12 of the mounting structure 1 while reducing transmission loss and then radiate the radio frequency signal efficiently.

Note that the antenna device 104 of Embodiment 4 can be used in the antenna module 200 mounted on the communication device 300, as is the case for the antenna device 101 of Embodiment 1.

### Embodiment 5>

An antenna device 105 according to Embodiment 5 will be described with reference to FIG. 8. The description of the antenna device 105 of Embodiment 5 focuses only on portions that differ from those of the antenna device 101 of Embodiment 1 and omits the other portions. As is the case for the antenna device 101 of Embodiment 1, the antenna device 105 of Embodiment 5 includes the mounting structure 1 described using FIGS. 1 and 2. FIG. 8 is a view illustrating a structure of the antenna device 105 of Embodiment 5. Note that FIG. 8 illustrates a section of the antenna device 105 having an L-shape when viewed from the X-axis direction.

As illustrated in FIG. 8, the antenna device 105 includes the dielectric 10 extending in the Y-axis direction and a dielectric 50 extending in the Z-axis direction, in other words, extending perpendicular to the dielectric 10. The antenna device 105 formed by the dielectric 10 and the dielectric 50 has a substantially L-shaped section. A system-in-package (SiP) module 60 that incorporates components, such as the RFIC 120 and a power module IC, is connected to a principal surface 50A of the dielectric 50 of the antenna device 105.

The antenna device 105 includes, in the dielectric 50, a ground electrode 51, a ground electrode 52, a radiation electrode 36, a feed wire 61, a feed wire 62, and the electrode plate 20. The ground electrode 51 and the ground electrode 52 are each disposed inside the dielectric 50 so as to stretch on the X-Z plane. The radiation electrode 36 is connected to the SiP module 60 via the feed wire 61 that extends in the Y-axis direction. The radiation electrode 36 is a tabular electrode that radiates, as a radio wave, a radio frequency signal transmitted from the SiP module 60 via the feed wire 61. The radiation electrode 36 is disposed inside the dielectric 50 so as to stretch on the X-Z plane. The electrode plate 20 is disposed so as to face toward the dielectric 10 and connected to the SiP module 60 via the feed wire 62.

The antenna device 105 includes the mounting structure 1 and a radiation electrode 35 in the dielectric 10. The principal surface 10A of the mounting structure 1 faces a side surface of the SiP module 60. In other words, the first line 11 and the second line 12 of the mounting structure 1 extend orthogonally to the principal surface 50A of the dielectric 50.

The first line 11 is connected to the electrode plate 20. The radiation electrode 35 is a tabular electrode that radiates, as a radio wave, a radio frequency signal transmitted from the mounting structure 1 and is disposed inside the dielectric 10 so as to stretch on the X-Y plane.

The radiation electrode 35 is connected to the second line 12 via a feed wire 63 that extends in the Z-axis direction.

When the radiation electrode 35 is viewed from the Z-axis direction, the length A5 of the radiation electrode 35 in the Y-axis direction is one half of the wavelength of a radio frequency signal transmitted through the substrate in the frequency band supported by the antenna device 105. In other words, the length A5 of the radiation electrode 35 in the Y-axis direction is one half of the wavelength of the radio frequency signal transmitted by the first line 11 and the second line 12 in the frequency band supported by the antenna device 105.

The length L of the stub 13 is one-fourth of the wavelength of a radio frequency signal transmitted through the substrate in the frequency band supported by the antenna device 105. In other words, the length L of the stub 13 is one-fourth of the wavelength of the radio frequency signal transmitted by the first line 11 and the second line 12 in the frequency band supported by the antenna device 105. From another perspective, the length L of the stub 13 is within ±30% of one half of the length A5 of the radiation electrode 35 in the Y-axis direction.

In the antenna device 105 structured as above, the first line 11 and the second line 12 of the mounting structure 1 are impedance-matched, and a radio frequency signal is transmitted from the electrode plate 20 to the first line 11 and further to the second line 12 while reducing transmission loss. The radio frequency signal transmitted to the second line 12 is further transmitted to the radiation electrode 35 and is radiated to the outside by the radiation electrode 35.

Accordingly, the antenna device 105 can receive the radio frequency signal transmitted from the electrode plate 20 via the first line 11 and the second line 12 of the mounting structure 1 while reducing transmission loss and then radiate the radio frequency signal efficiently.

### MODIFICATION EXAMPLES

The present disclosure is not limited to the above-described embodiments but is subjected to various modifications for application. Modification examples applicable to the present disclosure are described below.

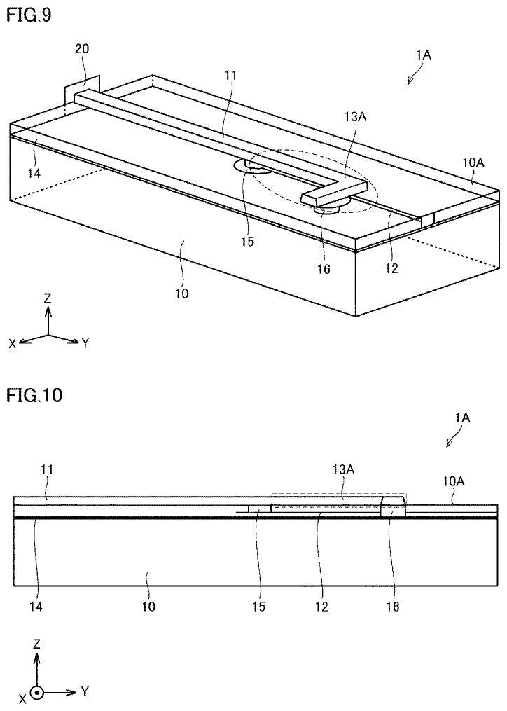

FIG. 9 is a perspective view illustrating a mounting structure 1A of the transmission line according to a modification example. FIG. 10 is a cross-sectional view illustrating the mounting structure 1A of the modification example. The mounting structure 1 according to the embodiments above includes the stub 13, which is an open stub having an open end. The mounting structure 1A according to the modification example, however, may include a stub 13A that is a shorted stub having a short-circuited end.

More specifically, as illustrated in FIGS. 9 and 10, a portion of the first line 11 extends in the positive Y-axis direction from the connection portion connected to the connecting conductor 15 and then bends toward the positive X-axis direction, and the end portion of the first line 11 is connected to the ground electrode 14 via a connecting conductor 16.

The length of the stub 13A, which is the shorted stub, is one half of the wavelength of a radio frequency signal transmitted through the substrate in the frequency band supported by the antenna device equipped with the mounting structure 1A. In other words, the length of the stub 13A is one half of the wavelength of the radio frequency signal transmitted by the first line 11 and the second line 12 in the frequency band supported by the antenna device.

Accordingly, the mounting structure of the present disclosure may include the stub 13A, which is the shorted stub, in place of the stub 13, which is the open stub. It is necessary, however, to design the stub 13A, which is the shorted stub, to have a greater length than that of the stub 13, which is the open stub. In addition, it is also necessary to bend the stub 13A from the Y-axis direction to the X-axis direction in order to connect the stub 13A to the ground electrode 14. Accordingly, in the case of using the stub 13A or the shorted stub, it is necessary to increase the size of the dielectric 10 compared with the case of using the stub 13 or the open stub. Accordingly, the mounting structure of the present disclosure may include the stub 13 or the open stub instead of the stub 13A or the shorted stub.

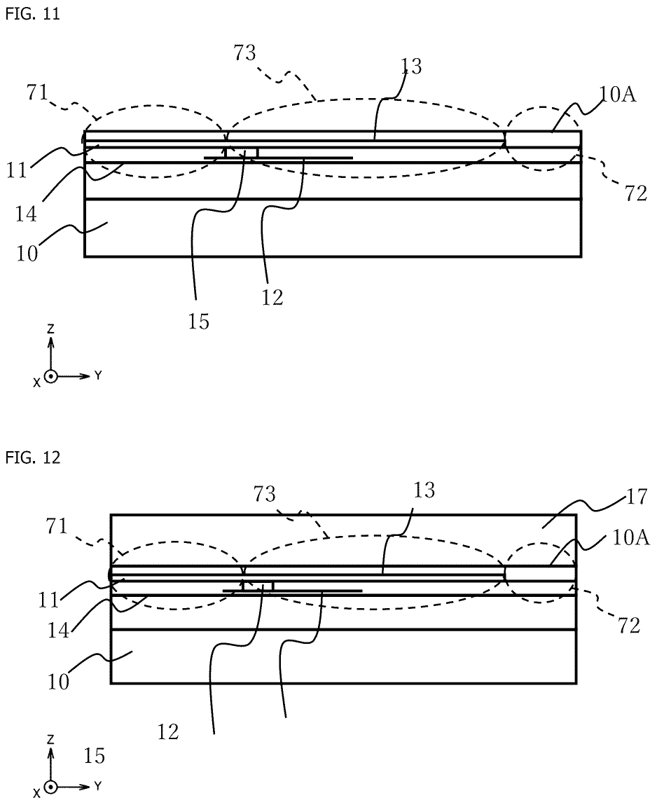

An antenna device according to Embodiment 6 will be described with reference to FIG. 11. The mounting structure of Embodiment 6 differs from Embodiment 1 in that the first line 11 is disposed on an inner layer of the dielectric 10 rather than on the principal surface 10A. More specifically, the first line 11 is formed on an inner layer of the dielectric 10 positioned above the inner layer on which the second line 12 is formed, with the first line 11 and the second line 12 separated by a portion of the dielectric 10 in the Z-axis direction. The stub 13 is likewise embedded within the dielectric 10 and extends from the connection portion of the first line 11 in the longitudinal direction. The dielectric layer above the first line 11 and the dielectric layer between the first line 11 and the second line 12 may have the same or different dielectric constants. Even with this configuration, the strip line 73 is formed with the second line 12 interposed between the stub 13, which is part of the first line 11, and the ground electrode 14, enabling the same favorable impedance matching as described in Embodiment 1.

As described in Embodiment 6 above, the first line 11 may be alternatively disposed on an inner layer of the dielectric 10.

An antenna device according to Embodiment 7 will be described with reference to FIG. 12. As with Embodiment 6, the strip line 73 is formed with the second line 12 interposed between the stub 13 and the ground electrode 14, enabling favorable impedance matching. The mounting structure of Embodiment 7 differs from Embodiment 6 in that a conductive layer 17 is disposed above the first line 11 within the dielectric 10, covering the first line 11 on the side opposite the second line 12 in the Z-axis direction. A further dielectric layer may be present above the conductive layer 17. The entire mounting structure is thus located within the multilayer substrate, with the first line 11 sandwiched between the conductive layer 17 and a portion of the dielectric 10, and the second line 12 positioned between the first line 11 and the ground electrode 14 in the Z-axis direction. This configuration further reduces signal radiation loss from the first line 11 by providing shielding above the first line 11. The conductive layer 17 may be a ground electrode or a signal shielding layer.

In the mounting structure 1 according to the embodiments above, the first line 11 and the second line 12 are shaped like cuboids, but the first line 11 and the second line 12 may have other shapes, such as cylinders. In such a case, the dimension (for example, diameter) of the first line 11 in a cross section taken in the Z-axis direction may be designed to be greater than the dimension (for example, diameter) of the second line 12 in a cross section taken in the Z-axis direction.

In the mounting structure 1 according to the embodiments above, the connecting conductor 15 has a cylindrical shape, but the connecting conductor 15 may have another shape, such as a cuboid.

In the mounting structure 1 according to the embodiments above, the stub 13 is a portion of the first line 11, but the stub 13 may be formed of a conductor separated from the first line 11. However, in the case of the conductor of the stub 13 being the same conductor of the first line 11, it is easier to achieve impedance matching compared with the case of the conductor of the stub 13 being different from that of the first line 11.

In the mounting structure 1 according to the embodiments above, when the principal surface 10A of the dielectric 10 is viewed from the Z-axis direction, the stub 13 completely overlaps the second line 12 in the width direction thereof (in the X-axis direction). The stub 13, however, may overlap the second line 12 at least partially in the width direction thereof (in the X-axis direction).

### <Aspects>

(Item 1) According to an aspect of the present disclosure, a mounting structure of a transmission line that transmits a signal includes: a dielectric; a ground electrode disposed at the dielectric; a first line disposed at the dielectric so as to oppose the ground electrode; a second line disposed at the dielectric so as to oppose the ground electrode at a position between the first line and the ground electrode in a normal direction being normal to the dielectric; a connecting conductor connecting the first line and the second line; and a stub extending from a connection portion of the first line, the connection portion being connected to the connecting conductor, the stub being disposed at the dielectric so as to oppose the ground electrode and the second line. In the normal direction, a thickness of the first line is greater than a thickness of the second line. The second line extends in a direction of the first line extending. The stub extends in an extending direction of the second line extending. When the dielectric is viewed from the normal direction, at least a portion of the stub overlaps the second line in the extending direction.

(Item 2) In the mounting structure according to Item 1 above, the first line is disposed on a principal surface of the dielectric.

(Item 3) In the mounting structure according to Item 1 or 2 above, in the normal direction, a thickness of the stub is equal to the thickness of the first line.

(Item 4) In the mounting structure according to any one of Items 1 to 3 above, the stub is part of the first line.

(Item 5) In the mounting structure according to any one of Items 1 to 4 above, when the dielectric is viewed from the normal direction, a width of the stub is greater than a width of the second line.

(Item 6) In the mounting structure according to any one of Items 1 to 5 above, when the dielectric is viewed from the normal direction, the stub completely overlaps the second line in a width direction of the second line.

(Item 7) In the mounting structure according to any one of Items 1 to 6 above, an impedance of a portion of the second line, the portion not overlapping the stub in the extending direction, is equal to an impedance of the first line.

(Item 8) In the mounting structure according to any one of Items 1 to 7 above, in the normal direction, a distance between the stub and the second line is equal to a distance between the second line and the ground electrode.

(Item 9) In the mounting structure according to any one of Items 1 to 8, an impedance of a portion of the second line, the portion overlapping the stub in the extending direction, is smaller than an impedance of the first line.

(Item 10) In the mounting structure according to any one of Items 1 to 9 above, when the dielectric is viewed from the normal direction, a width of the first line is greater than the width of the second line.

(Item 11) In the mounting structure according to any one of Items 1 to 10 above, when the dielectric is viewed from the normal direction, a cross-sectional dimension of the connecting conductor is greater than the width of the second line and smaller than the width of the first line.

(Item 12) In the mounting structure according to any one of Items 1 to 11 above, an end of the stub opposite to the connection portion is open.

(Item 13) In the mounting structure according to any one of Items 1 to 12 above, a length of the stub in the extending direction is one-fourth of a wavelength of a radio frequency signal transmitted by the first line and the second line.

(Item 14) The mounting structure according to any one of Items 1 to 13 above, wherein the connecting conductor extends in the normal direction between the first line and the second line.

(Item 15) The mounting structure according to any one of Items 1 to 14 above, wherein the first line is disposed on an inner layer of the dielectric.

(Item 16) The mounting structure according to any one of Items 1 to 15 above, wherein the first line is covered on a side opposite to the second line by a conductive layer disposed at the dielectric.

(Item 17) The mounting structure according to any one of Items 1 to 16 above, wherein an end of the stub opposite to the connection portion is connected to the ground electrode via a second connecting conductor, and a length of the stub in the extending direction is one-half of a wavelength of a radio frequency signal transmitted by the first line and the second line.

(Item 18) According to another aspect of the present disclosure, an antenna module includes the mounting structure according to any one of Items 1 to 17 above and a radiation electrode that radiates a radio frequency signal transmitted from the mounting structure.

(Item 19) According to another aspect of the present disclosure, a communication device is equipped with the antenna module according to Item 18 above.

The embodiments disclosed herein should be construed as illustrative and not as restrictive in all respects. The scope of the present disclosure is defined by the claims, not by the above description of the embodiments, and is intended to include all variations and equivalents within the scope of the claims.

### REFERENCE SIGNS LIST

1, 1A mounting structure
10, 50 dielectric
10A, 50A principal surface
11 first line
12 second line
13, 13A stub
14, 51, 52 ground electrode
15, 16 connecting conductor
17 conductive layer
20 electrode plate
31, 32, 33, 34, 35, 36 radiation electrode
60 module
61, 62, 63 feed wire
71, 72 microstrip line
73 strip line
101, 102, 103, 104, 105 antenna device
200 antenna module
300 communication device
311, 321 feed point
312 center point
322 grounding point
341 first radiation electrode
341A first bend
342 second radiation electrode
342A second bend

1. A mounting structure of a transmission line that transmits a signal, the mounting structure comprising:
a dielectric;
a ground electrode disposed at the dielectric;
a first line disposed at the dielectric so as to oppose the ground electrode in a normal direction being normal to the dielectric;
a second line disposed at the dielectric so as to oppose the ground electrode at a position between the first line and the ground electrode in the normal direction;
a connecting conductor connecting the first line and the second line; and
a stub extending from a connection portion of the first line, the connection portion being connected to the connecting conductor, the stub being disposed at the dielectric so as to oppose the ground electrode and the second line, wherein
in the normal direction, a thickness of the first line is greater than a thickness of the second line,
the first line extends in a longitudinal direction,
the second line extends in the longitudinal direction,
the stub extends from the connection portion along the longitudinal direction, and
when the dielectric is viewed from the normal direction, at least a portion of the stub overlaps the second line along the longitudinal direction.

2. The mounting structure according to claim 1, wherein
the first line is disposed on a principal surface of the dielectric.

3. The mounting structure according to claim 1, wherein
in the normal direction, a thickness of the stub is equal to the thickness of the first line.

4. The mounting structure according to claim 3, wherein
the stub is part of the first line.

5. The mounting structure according to claim 1, wherein
when the dielectric is viewed from the normal direction, a width of the stub is greater than a width of the second line.

6. The mounting structure according to claim 1, wherein
when the dielectric is viewed from the normal direction, the stub completely overlaps the second line in a width direction of the second line.

7. The mounting structure according to claim 1, wherein
an impedance of a portion of the second line, the portion not overlapping the stub along the longitudinal direction, is equal to an impedance of the first line.

8. The mounting structure according to claim 1, wherein
in the normal direction, a distance between the stub and the second line is equal to a distance between the second line and the ground electrode.

9. The mounting structure according to claim 1, wherein
an impedance of a portion of the second line, the portion overlapping the stub in the longitudinal direction, is smaller than an impedance of the first line.

10. The mounting structure according to claim 1, wherein
when the dielectric is viewed from the normal direction, a width of the first line is greater than the width of the second line.

11. The mounting structure according to claim 1, wherein
when the dielectric is viewed from the normal direction, a cross-sectional dimension of the connecting conductor is greater than the width of the second line and smaller than the width of the first line.

12. The mounting structure according to claim 1, wherein
an end of the stub opposite to the connection portion is open.

13. The mounting structure according to claim 1, wherein
a length of the stub in the longitudinal direction is one-fourth of a wavelength of a radio frequency signal transmitted by the first line and the second line.

14. The mounting structure according to claim 1, wherein the connecting conductor extends in the normal direction between the first line and the second line.

15. The mounting structure according to claim 1, wherein the first line is disposed on an inner layer of the dielectric.

16. The mounting structure according to claim 15, wherein the first line is covered on a side opposite to the second line by a conductive layer disposed at the dielectric.

17. The mounting structure according to claim 1, wherein an end of the stub opposite to the connection portion is connected to the ground electrode via a second connecting conductor, and a length of the stub in the longitudinal direction is one-half of a wavelength of a radio frequency signal transmitted by the first line and the second line.

18. An antenna module comprising:
the mounting structure according to claim 1; and
a radiation electrode that radiates a radio frequency signal transmitted from the mounting structure.

19. The antenna module according to claim 18, wherein the radiation electrode is one of: a patch antenna electrode, a planar inverted F antenna electrode, a monopole antenna electrode, or a dipole antenna electrode.

20. A communication device equipped with the antenna module according to claim 18.
